(19) United States
(12) Patent Application Publication
(10) Pub. No.: US 2010/0103446 A1
(43) Pub. Date: Apr. 29, 2010

(54) METHODS AND SYSTEMS FOR PRINTING DOCUMENTS WITH SEMI-TRANSPARENT GRAPHICAL ELEMENTS

(75) Inventor: Martin Bailey, Cambridge (GB)

Correspondence Address: DARBY & DARBY P.C., P.O. BOX 770, Church Street Station, New York, NY, 10008-0770, US

(73) Assignee: Global Graphics Software Limited, Cambridge (GB)

(21) Appl. No.: 12/259,801

(22) Filed: Oct. 28, 2008

(51) Int. Cl. G06F 3/12

(52) U.S. Cl. 358/1.15

(57) ABSTRACT

A method of processing a page for printing includes processing each component of the page, or a portion of the page, into a display list. A plurality of element streams is generated from at least a portion of the display list. Each component of the element streams is identified as being an invariant component or a varying component. For each invariant component, it is determined whether that invariant component has been serialized into at least one of the element streams and, if not, the invariant component is serialized into at least one of the element streams and stored.

### FIELD

The present invention is directed to the area of printers, printed documents, and printer software and hardware, as well as to methods of printing. In addition, the present invention is directed to methods of printing documents with invariant and variant data, including semi-transparent graphical elements.

### BACKGROUND

In 2001 Adobe Systems released the specification for version 1.4 of the Adobe Portable Document Format (PDF) specification, which included the ability to place graphical elements that are semi-transparent on a page. More recently Microsoft's XML Paper Specification (XPS) allows the same kind of constructs.

Semi-transparent graphical elements may be used for a variety of purposes, including drop-shadows. Rasterizing a page that includes semi-transparent objects often requires significantly more processing than one that does not. The additional work can include transforming the color space in which data is stored and computing and merging the contribution of multiple objects to a single pixel in the output raster. In many cases data is also copied more often than is required for a page containing no transparent objects. As a result a RIP (raster image processor) performing such rasterization can take significantly longer than processing pages without transparency.

The complexity of processing pages containing semi-transparent objects is often increased because the contribution of each graphical element to the final rasterized result may need to be computed in a different color space (referred to as the blend color space) as compared to that to be used in rasterizing the final raster from the RIP. Thus, if a RIP produces a raster in CMYK (Cyan, Magenta, Yellow and Black; a common set of colorants for print), it may need to merge semi-transparent objects with underlying objects in another space, such as sRGB (a standard RGB (Red Green Blue) color space created cooperatively by HP and Microsoft for use on monitors, printers, and the Internet). In the case of PDF transparency a stack of multiple semi-transparent objects overlaying each other may each have a different blend color space, requiring the color definitions of the data for underlying objects to be transformed into a different color space as such new objects are added.

For many kinds of printing the additional time introduced by a longer rasterization process may be a nuisance, but does not greatly complicate a workflow or impact on a print company's profits. If a press-run will take several hours, for instance, then a few additional minutes to rasterize rasters from which printing plates will be made may mean that scheduling of plate-setting may need to be well controlled, but is unlikely to lead to a late delivery of the printed work.

This can even be the case where a digital production press is used to image the final pages. Many jobs on such presses are described as “short-run” or “print-on-demand”, and it is common for up to 500 copies of each page to be printed. Thus the additional rasterization time is amortized over all of those copies.

There are some situations, however, where every page to be printed is different. These include transactional printing jobs (for example, credit card statements, telephone bills, etc) and variable data printing jobs, often used for direct mail and other personalized communications. It is typically desirable for this kind of printing to try to ensure that the digital production press itself is running at, or very near, engine speed at all times. In other words, preferably rasterization systems should be able to deliver page rasters to the print engine as fast as it can consume and image them.

The technology of digital production presses is still relatively new, and engine speeds are rising rapidly as they are developed further. In parallel with that the use of semi-transparent graphical elements on pages is also rising as tools become more widely available and as designers realize the effects that can be achieved.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a block diagram of a printing system, according to the invention;

FIG. 2 is a flow chart of one embodiment of a method of printing a page, according to the invention; and

FIG. 3 is a flow chart of another embodiment of a method of printing a page, according to the invention.

### DETAILED DESCRIPTION

The present invention is directed to the area of printers, printed documents, and printer software and hardware, as well as to methods of printing. In addition, the present invention is directed to methods of printing documents with invariant and variant data, including semi-transparent graphical elements.

The methods, systems, and devices described herein may be embodied in many different forms and should not be construed as limited to the embodiments set forth herein. Accordingly, the methods, systems, and devices described herein may take the form of an entirely hardware embodiment, an entirely software embodiment or an embodiment combining software and hardware aspects. The methods described herein can be performed using any type of computing device, such as a computer or printer, that includes a processor or any combination of computing devices where each device performs at least part of the process.

Suitable computing and printer devices typically include mass memory and typically include communication between devices. The mass memory illustrates a type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Methods of communication can include both wired and wireless (e.g., RF, optical, or infrared) communications methods and such methods provide another type of computer readable media; namely communication media. Communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

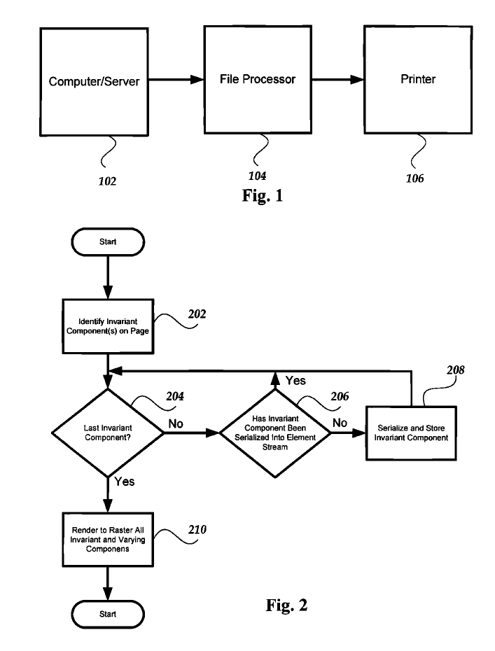

FIG. 1 illustrates one embodiment of a system for printing documents. A computer or server 102 generates or stores a file to be used in printing the document. For example, the document to be printed can be created on a computer, which may be a workstation with a human operator; or created or retrieved from a server, such as the report generator on a database; or created or retrieved from a supplementary server that aggregates graphic designs from one source with data from a second source. The computer or server 102 typically includes a printer driver.

A file containing the document can be provided, for example, using the printer driver, to a file processor 104 (such as a Raster Image Processor (RIP) or a Digital Front End (DFE)) to convert the file into a format useable by the printer 106 to print the document. The file processor 104 can be, at least in part, included with the printer 106 or the computer/server 102 or both. For example, the file processor is a server computer which may optionally have hardware assistance included within it. As another example, the file processor is sometimes within the casing of the printer or in a separate box that is dedicated to that printer. In some embodiments, the interpreting and rendering components of the file processor may be both in a device that is outside of the printer casing, both within the casing of the printer, or separated such that, for example, the interpreter is in a device outside the printer casing and the renderer is on a computer board or second computer that is mounted within the printer casing.

Many variable data print jobs contain a combination of relatively complex invariant data that appears on all, or a significant subset, of final pages with relatively simple varying data that appears only once. As an example, consider a direct mail postcard for the opening of a new store. That may include a large image covering the whole of the card, plus a map and an invitation to the recipient to attend the opening. Every card would include the same image and map, and much of the text of the invitation may also be identical in all cases. In contrast the recipient's name and address would be different on every card. In other cases there may be a small number of variations (the image may be selected from a set of 10, based on previous buying habits of the recipient, for example). More complex variable data print jobs may include multiple pages, each of which follows the same conceptual pattern as the postcard example described above.

As a result, variable data print systems have developed in a way that separates invariant and varying data. As far as is possible the invariant data is rasterized only once. Varying data is then rasterized for each page of the print job. Finally, the rasters produced for the invariant data are stitched together, post-RIP, with those produced for the varying data to produce a whole-page raster that can be delivered to the print engine for imaging. Such stitching is often performed in specialized hardware closely associated with the print engine itself to enable very rapid delivery to the imaging heads inside the print engine.

A number of page description languages (PDLs) have been developed to describe data for variable data printing. Examples include Xerox's VIPP (Variable-data Intelligent PostScript Printware) and Creo's VPS (Variable Print Specification). Many of these were developed from the PostScript language from Adobe Systems, which does not include the ability to describe semi-transparent objects. As a result, those variable data formats do not either.

There are also some meta-PDLs for variable data print. These comprise a relatively lightweight print control stream that refers to pages in associated PDL files. Each PDL ‘page’ may be placed within the area of a final print page, possibly with some scaling, rotation or clipping. A PDL ‘page’ placed in this way may be referred to as a “mark”. Thus a final print page may be built up from multiple marks, each described by one PDL ‘page’, a model designed to align with the capabilities of stitching multiple rasters together post-RIP. An example of a meta-PDL for variable data print is PPML (Personalized Print Markup Language) from PODi (the Print On Demand initiative).

Meta-PDLs may allow the print control stream to refer to marks in PDLs (such as PDF) that do support semi-transparency. In such cases however they may either explicitly define the rasterized result of one mark as being fully opaque with respect to underlying marks, or do not make any statements about the required result, reducing the reliability of printing such jobs because different solutions may produce different printed results.

Some PDLs, even those which were not originally designed specifically for use in variable data print workflows, include structures that were designed to hold data that may be re-used. These include PostScript forms, PDF Form XObjects and XPS remote resources. These structures do not carry any data about the number of times their content is used within a job, and only limited data about their scope, but it is still possible to assume that they represent invariant data in at least some circumstances.

In the absence of semi-transparent objects on pages all invariant and varying data may be rasterized into rasters in the same color space for the print engine. Post-RIP stitching of such rasters is then relatively simple, as the data for each colorant may be independently processed. This procedure is complicated by the use of semi-transparent objects having a blend color space that does not match the color space of the final page raster that is to be delivered to the print engine, and even more so if multiple blend color spaces are used within a single page. In such cases, stitching of post-RIP rasters may include multiple color transforms, making the specialized hardware/software to do so significantly more complex and expensive, and often reducing the page throughput rate that may be obtained. In some situations, such as two marks overlaying each other and each containing semi-transparent elements with each of those semi-transparent elements using a different blend color space, it may be very difficult and time-consuming, if not impossible, to obtain a strictly correct page raster from a post-RIP stitching system.

A RIP may be split into two primary phases: interpretation and rendering. Additional processing (such as imposition, color management, trapping, linearization, screening etc) may occur as part of one of those phases, or between or after them.

Interpretation includes the parsing of a page of a PDL. Each graphical element on that page is recorded into an intermediate format, often described as a display list. Each element is processed depending on the type of the element and, in some cases, aspects of its placement on the page. As an example, one or more of the following transformations may be applied to a given element: 1) Images can be split into tiles or bands. If rotated by a multiple of 90° the source raster data may be re-ordered. If rotated by an arbitrary amount each pixel may be converted into an individual quadrilateral 2) Vector objects can be converted into one of a small number of simplified representations. Curves can be flattened to a series of straight lines suitable for representing that curve at the resolution and quality level required for a particular implementation. 3) Characters can be recorded as references to a specific glyph from a specific font at a specific size. An example of such processing is described in U.S. Provisional Patent Applications Ser. Nos. 61/046,274 and 61/057,197, both of which are incorporated herein by reference.

Most, if not all, graphical elements in the source PDL may be described as being a raster format (mainly photographic, scanned or synthetic images) or as being a vector format (lines, fills, text). The term display list, as used in this description, refers to a structure in which data represented as raster in the source PDL is primarily still stored as raster in the display list, and data represented as vector in the source PDL is primarily still stored as vector in the display list.

For a RIP to generate the output raster the display list should provide sufficient data to represent the same visual appearance as the original PDL page.

In at least some RIPs the display list format is a complex structure, such as a directed acyclic graph or R-tree, and the graphical elements represented within it are also relatively complex. As a result it may be difficult to serialize as-is into a stream and therefore either to store persistently, or to transfer to a separate processing module.

The complexity of the object formats stored within the display list also typically leads to complex processing during rendering, using many operations that may be difficult to achieve efficiently and cost-effectively in a hardware implementation.

In one embodiment, the display list structure may be transformed into a second representation such that it a) continues to accurately represent the visual appearance of the PDL page, b) is simple enough to enable it to be very efficiently parsed and rendered to generate a raster, c) is complex enough to enable it to represent the semi-transparency constructs from PDL pages in at least the most common cases, d) may be serialized into a stream for persistent storage and for transfer between processing modules, and e) is compact enough to allow storage of many page components, either in RAM or in a more persistent format, such as on a hard disk or the like, and to reduce the time and communication bandwidth to transmit from one processing module to another.

This new representation can be described as an element stream. An element stream may be created for a whole PDL page or for a portion of a page. That portion of the page may be defined in any manner, however, it may be convenient to define the portion as an identified set of graphical elements (e.g., in PDF terminology, a Form XObject, or a transparency group) rather than a specified area of the page.

An element stream may be stored in computer memory (RAM), on a computer hard disk, or in some other form.

In at least some embodiments, the element stream retains vector data from the source PDL primarily in vector form, and raster data from the PDL primarily in raster form.

In at least some embodiments, a PDL or meta-PDL page or portion of a page representing a variable data print job will be processed. Invariant components of the job are identified, and element streams for those invariant components are created and stored.

Identification of invariant components may be performed using any suitable method. For example, when the print job is supplied in a meta-PDL such as PPML, or in some PDLs designed for variable data printing, such as VIPP or VPS, the invariant components are often explicitly identified in the job data. When the job is supplied in a general purpose PDL such as PostScript, PDF or XPS, invariant components may be identified by, for example, an analysis of the job files before interpretation, or may be identified dynamically by assessment of previous use during interpretation. Thus, a particular PDF Form XObject or XPS remote resource may be identified as an invariant component of the page on the second or third time that it is used by a single print job. In at least some embodiments, the position, scaling and rotation of large data units such as images, may be recorded independently of any structure placed around them within the PDL page.

One embodiment is illustrated in FIG. 2 and includes a processing module that identifies invariant components of each page (step 202). For every invariant component (step 204), it is determined whether that invariant component has already been serialized into an element stream (step 206). If not, an element stream is serialized and stored for the component (step 208). This storage may be in RAM, on hard disk or in any other form of storage media.

For every component of the page (invariant or varying), reading in the same order in which they were represented in the source PDL page), the varying components are rendered to raster from the display list representation and the stored element stream for invariant components is parsed and rendered into the same raster (step 210).

Rendering from stored element streams helps to avoid the relatively complex work of re-interpreting the original PDL representation of the invariant component, in favor of the typically much faster and memory-efficient parsing of the element stream. It also can avoid repeatedly performing the simplification of graphical elements from the format stored in the display list into the format in the element stream.

As the element stream also records information regarding semi-transparent objects, this methodology ensures that pages containing one or more marks that include semi-transparent objects are processed to create correct rasters.

In another embodiment, element streams are created for both invariant and varying components of each page. These streams are made available to a processing module which is capable of parsing and merging streams and rendering the result.

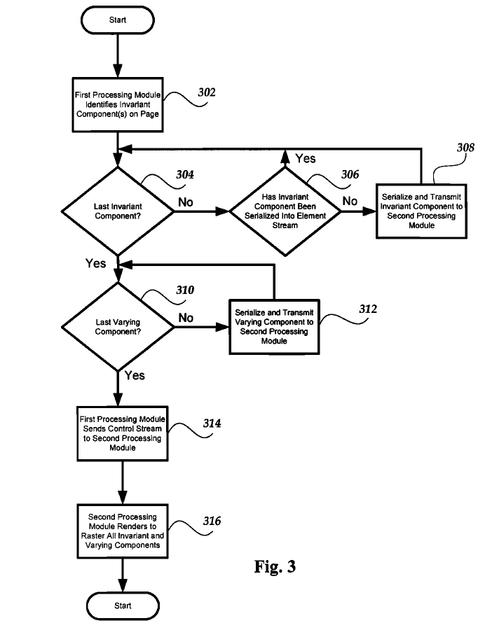

In one embodiment illustrated in FIG. 3, a first processing module (most commonly in software, but could be implemented in hardware or a combination of hardware and software) identifies invariant components of each page (step 302) and, for every invariant component (step 304), determines whether that invariant component has already been serialized into an element stream (step 306). If it has not previously been serialized, the first processing module serializes and transmits an element stream for the component to the second processing module (step 308). For every variant component (step 310), the first processing module serializes and transmits an element stream for the component to the second processing module (step 312). The first processing module transmits a control stream to the second processing module identifying the element streams for all invariant and varying components of each final page to be printed, including their positions on that page (step 314). A second processing module (most commonly a combination of software with hardware assistance, although this could be implemented using software or hardware alone) receives element and control streams from the first processing module and, for every page described in the control stream, renders the sequence of element streams identified for that page, at the required position on the page (step 316).

The element stream format is designed such that it can be parsed and rendered efficiently in a hardware implementation (such as a custom ASIC, FPGA, DSP or GPGPU); thus the second processing module may be implemented on custom hardware closely linked with the print engine, allowing very high speed delivery to the marking heads within that print engine.

At least some embodiments produce final rasters in regions, which may be horizontal bands across the width of the page, or may be an alternative division of the page, such as tiles or vertical stripes. The element stream format used in at least some embodiments is also divided into regions in the same way. Each graphical element interpreted from the source PDL page is associated with one or more regions, depending on whether it falls entirely within the area defined by one region, or whether it crosses region boundaries and therefore falls within more than one region.

The element stream for each component of a page therefore includes a division for each page region. Each division is largely independent of the divisions for other regions of the same component and of the element streams for other components. Any resources shared between divisions, or between components or final pages are made available to the rendering module in advance of all pages, components and divisions that require that resource. Thus a sufficiently powerful system may process multiple pages, components or divisions in parallel.

An embodiment may choose to use the same size of region for all marks and pages to facilitate merging of element streams and a display list or of multiple element streams.

Further, in one embodiment a user or the system may choose to set the same region size, and also to align regions in marks with regions on the final page. When a mark is placed at the same position on every page the memory requirements may be reduced and performance increased. If marks are placed at different vertical positions on different pages then this approach may lead to multiple streams for marks derived from the same source PDL data.

In at least some embodiments, the system may determine whether any semi-transparent graphical elements occur on a page (including both invariant marks and varying data). If a page contains no semi-transparent elements then marks for invariant data are rendered to raster immediately. The conversion may occur instead of the serialization into an element stream, and the raster(s) for invariant data are then merged with the rendering of varying data from the original display list. In other embodiments the element stream for the invariant data is transmitted to the second processing module and rendered to raster there. The element stream(s) for the varying data are then merged with the pre-rendered rasters for the invariant data in the second processing module.

In at least some embodiments, the user or system may choose to merge an invariant page component with another invariant component that occurs immediately before it in the source PDL page description into a single invariant component in order to simplify merging in the page rendering phase. This provides particular benefit when the varying components of a page are not interleaved with invariant components.

In a resource-constrained environment (with finite disk space and/or memory) a user or the system may choose to discard stored element streams or stored rasters (or both) and regenerate them as needed, particular if the available storage is filled or nearly filled. This may require two-way communication between the two processing modules.

Some PDLs and meta-PDLs provide identification of individual marks in a way that can be persisted between jobs; examples include the ‘global’ scope in PPML, and the metadata fields associated with PDF reference XObjects in PDF/X-5g. When processing such jobs element streams and/or rasters for invariant data may also be stored between jobs and re-used without requiring regeneration. This allows efficient processing of a variety of use cases, including, for example, 1) a print run for pre-loading of the required collection of rasters and element streams, or for approval purposes, followed by a second print run to generate the final print output and 2) ‘chunking’ workflows, in which a series of short jobs are delivered to the print system as an alternative to a single very long one.

It will be understood that each block of the flowchart illustrations in FIGS. 2 and 3, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The computer program instructions, or portions of the computer program instructions, can be stored on any suitable computer-readable medium including, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The above specification, examples and data provide a description of the manufacture and use of the composition of the invention. Since many embodiments of the invention can be made without departing from the spirit and scope of the invention, the invention also resides in the claims hereinafter appended.

What is claimed as new and desired to be protected by Letters Patent of the United States is:

1. A method of processing a page for printing, the method comprising:
processing each component of the page, or a portion of the page, into a display list; and
generating a plurality of element streams from at least a portion of the display list, wherein each component of the element streams is identified as being an invariant component or a varying component, wherein generating the plurality of element streams comprises, for each invariant component, determining whether that invariant component has been serialized into at least one of the element streams and, if not, serializing the invariant component into at least one of the element streams and storing the invariant component.

2. The method of claim 1, further comprising rendering to raster all of the invariant and varying components of the element streams.

3. The method of claim 2, further comprising printing the page, or the portion of the page, from the raster of all of the invariant and varying components.

4. The method of claim 2, further comprising storing at least one of the element streams after generating that element stream and prior to rendering to raster that element stream.

5. The method of claim 1, wherein generating an element stream further comprises serializing each varying component into at least one of the element streams.

6. The method of claim 1, wherein the plurality of element streams are generated in a first processing module and further comprising rendering to raster all invariant and varying components of the element streams using a second processing module.

7. The method of claim 6, wherein further comprising, for each invariant component, transmitting the element stream into which that invariant component has been serialized to the second processing module.

8. The method of claim 7, wherein further comprising, for each varying component, transmitting the element stream into which that varying component has been serialized to the second processing module.

9. The method of claim 7, further comprising transmitting a control stream from the first processing module to the second processing module, the control stream identifying the invariant and varying components from the plurality of element streams.

10. The method of claim 1, wherein each invariant component is rendered into a separate element stream.

11. A system for printing a page, comprising:
a printer;
at least one processor in communication with the printer; and
a computer readable storage medium having processor-executable instructions, the processor-executable instructions when installed onto the system enables the system to perform actions, comprising:
processing each component of the page, or a portion of the page, into a display list; and
generating a plurality of element streams from at least a portion of the display list, wherein each component of the element streams is identified as being an invariant component or a varying component, wherein generating the plurality of element streams comprises, for each invariant component, determining whether that invariant component has been serialized into at least one of the element streams and, if not, serializing the invariant component into at least one of the element streams and storing the invariant component.

12. The system of claim 11, further comprising a computer or server in electrical communication with the at least one processor to provide the page to the at least one processor.

13. The system of claim 12, wherein at least one of the at least one processor is part of the computer or server.

14. The system of claim 12, wherein at least one of the at least one processor is separate from the printer and from the computer or server.

15. The system of claim 11, wherein at least one of the at least one processor is part of the printer.

16. The system of claim 11, wherein the processor-executable instruction enable the system to perform addition actions, comprising rendering to raster all of the invariant and varying components of the element streams.

17. The system of claim 16, wherein the processor-executable instruction enable the system to perform addition actions, comprising printing the page, or the portion of the page, from the raster of all of the invariant and varying components.

18. A computer readable storage medium having processor-executable instructions, the processor-executable instructions when installed onto a system enable the system to perform actions, comprising:
processing each component of the page, or a portion of the page, into a display list; and
generating a plurality of element streams from at least a portion of the display list, wherein each component of the element streams is identified as being an invariant component or a varying component, wherein generating the plurality of element streams comprises, for each invariant component, determining whether that invariant component has been serialized into at least one of the element streams and, if not, serializing the invariant component into at least one of the element streams and storing the invariant component.

19. The computer readable storage medium of claim 18, wherein the processor-executable instruction enable the system to perform addition actions, comprising rendering to raster all of the invariant and varying components of the element streams.

20. The computer readable storage medium of claim 18, wherein the processor-executable instruction enable the system to perform addition actions, comprising printing the page, or the portion of the page, from the raster of all of the invariant and varying components.
